(19) United States
(12) Patent Application Publication
(10) Pub. No.: US 2019/0026606 A1
(43) Pub. Date: Jan. 24, 2019

(54) TO-BE-DETECTED INFORMATION GENERATING METHOD AND APPARATUS, LIVING BODY DETECTING METHOD AND APPARATUS, DEVICE AND STORAGE MEDIUM

(71) Applicant: BEIJING BAIDU NETCOM SCIENCE AND TECHNOLOGY CO., LTD., Beijing (CN)

(72) Inventors: Zhibin HONG, Beijing (CN); Jingtuo LIU, Beijing (CN)

(73) Assignee: BEIJING BAIDU NETCOM SCIENCE AND TECHNOLOGY CO., LTD., Beijing (CN)

(21) Appl. No.: 16/029,066

(22) Filed: Jul. 6, 2018

(30) Foreign Application Priority Data
Jul. 20, 2017 (CN) 2017105961102

(51) Int. Cl. G06K 9/62; G06K 9/00

(52) U.S. Cl. CPC G06K 9/6262; G06K 9/00288

(57) ABSTRACT

The present disclosure provides a to-be-detected information generating method and apparatus, a living body detecting method and apparatus, a device and a storage medium, wherein the method comprises: obtaining a user's to-be-detected information, the to-be-detected information including human face video shot with a smart terminal and movement information of the smart terminal during the shooting of the human face video, wherein a user needs to move the smart terminal as required during the shooting of human face video; determining whether the human face in the human face video is a living body according to the to-be-detected information. The solution of the present disclosure can be applied to improve accuracy of the detection results.

The present application claims the priority of Chinese Patent Application No. 201710596110.2, filed on Jul. 20, 2017, with the title of “To-be-detected information generating method and apparatus, living body detecting method and apparatus, device and storage medium”. The disclosure of the above applications is incorporated herein by reference in its entirety.

### FIELD OF THE DISCLOSURE

The present disclosure relates to computer application technologies, and particularly to a to-be-detected information generating method and apparatus, a living body detecting method and apparatus, a device and a storage medium.

### BACKGROUND OF THE DISCLOSURE

As compared with other biological feature recognition technologies, a human face recognition technology has unique advantages in practical application: human face can be directly acquired via a camera, and the recognition procedure may be completed in a non-contacting manner conveniently and quickly.

Currently, human face recognition technology is already applied to many fields such as financing, education, scenic spots, travel and transport and social insurance. However, the human face recognition technology brings about convenience as well as some problems. For example, human face can be easily acquired so that human face can be duplicated by some people in a picture or video manner to achieve the purpose of stealing information. Particularly in the new financing industry, human face recognition technology is already gradually applied to remote account opening, money withdrawal, payment and so on, and involves users' interests.

To this end, a living body detection technology is proposed in the prior art. Plainly speaking, the so-called living body detection means detecting that the face corresponds to a “living person” during human face recognition.

Sources of non-living bodies (namely, attacks) are wide, and include photos and video displayed on a mobile phone or Pad, and printed photos on different materials (including curving, folding, clipping and hole-digging in various cases), and so on.

The living body detection is applied on important occasions such as social insurance and online account opening. For example, pension cannot be withdrawn unless an elderly user's identity is determined authentic and the elderly user is still alive through verification. Upon online account opening, this can ensure authenticity, validity and safety of the user information.

In a conventional living body detection manner, it is possible to use a camera to collect user pictures, perform feature extraction for user pictures, and then determine whether the user is a living body according to the extracted features.

However, the accuracy of detection results in this manner is lower, and a non-living body is probably mistaken as a living body.

### SUMMARY OF THE DISCLOSURE

In view of the above, the present disclosure provides a to-be-detected information generating method and apparatus, a living body detecting method and apparatus, a device and a storage medium, which can improve the accuracy of detection results.

Specific technical solutions are as follows:

A to-be-detected information generating method, comprising:

obtaining human face video shot with a smart terminal when living body detection needs to be performed for a user;

obtaining movement information of the smart terminal during the shooting of the human face video, wherein the user needs to move the smart terminal as required during the shooting of human face video;

upon completion of the shooting, sending the human face video and the movement information of the smart terminal to a living body detecting system as the to-be-detected information, so that the living body detecting system determines whether the human face in the human face video is a living body according to the to-be-detected information.

According to a preferred embodiment of the present disclosure, the moving the smart terminal comprises:

moving the smart terminal farther or closer according to a random requirement.

A living body detecting method, comprising:

obtaining a user's to-be-detected information, the to-be-detected information including human face video shot with a smart terminal and movement information of the smart terminal during the shooting of the human face video, wherein a user needs to move the smart terminal as required during the shooting of human face video;

determining whether the human face in the human face video is a living body according to the to-be-detected information.

According to a preferred embodiment of the present disclosure, the moving the smart terminal comprises:

moving the smart terminal farther or closer according to a random requirement.

According to a preferred embodiment of the present disclosure, the determining whether the human face in the human face video is a living body according to the to-be-detected information comprises:

inputting the to-be-detected information into a classification model obtained by pre-training, to obtain an output detection result about whether the human face in the human face video is a living body.

According to a preferred embodiment of the present disclosure, before obtaining the user's to-be-detected information, the method further comprises:

respectively obtaining positive samples and negative sample as training data;

training according to the obtained training data to obtain the classification model.

A to-be-detected information generating apparatus, comprising: a generating unit and a sending unit;

the generating unit is configured to obtain human face video shot with a smart terminal when living body detection needs to be performed for a user; obtain movement information of the smart terminal during the shooting of the human face video, wherein the user needs to move the smart terminal as required during the shooting of human face video;

the sending unit is configured to, upon completion of the shooting, send the human face video and the movement information of the smart terminal to a living body detecting system as the to-be-detected information, so that the living body detecting system determines whether the human face in the human face video is a living body according to the to-be-detected information.

According to a preferred embodiment of the present disclosure, movement of the smart terminal comprises: moving farther and closer.

A living body detecting apparatus, comprising: an obtaining unit and a detecting unit;

the obtaining unit is configured to obtain a user's to-be-detected information, the to-be-detected information including human face video shot with a smart terminal and movement information of the smart terminal during the shooting of the human face video, wherein the user needs to move the smart terminal as required during the shooting of human face video;

the detecting unit is configured to determine whether the human face in the human face video is a living body according to the to-be-detected information.

According to a preferred embodiment of the present disclosure, movement of the smart terminal comprises: moving farther and closer.

According to a preferred embodiment of the present disclosure, the detecting unit inputs the to-be-detected information into a classification model obtained by pre-training, to obtain an output detection result about whether the human face in the human face video is a living body.

According to a preferred embodiment of the present disclosure, the apparatus further comprises: a pre-processing unit;

the pre-processing unit is configured to respectively obtain positive samples and negative sample as training data, and train according to the obtained training data to obtain the classification model.

A computer device, comprising a memory, a processor and a computer program which is stored on the memory and runnable on the processor, wherein the processor, upon executing the program, implements the above-mentioned to-be-detected information generating method.

A computer-readable storage medium on which a computer program is stored, wherein the program, when executed by a processor, implements the above-mentioned to-be-detected information generating method.

A computer device, comprising a memory, a processor and a computer program which is stored on the memory and runnable on the processor, wherein the processor, upon executing the program, implements the above-mentioned living body detecting method.

A computer-readable storage medium on which a computer program is stored, wherein the program, when executed by a processor, implements the above-mentioned living body detecting method.

As can be seen from the above introduction, according to the solutions of the present disclosure, it is feasible to obtain the user's to-be-detected information, the to-be-detected information including human face video shot with the smart terminal and movement information of the smart terminal during the shooting of the human face video, wherein the user needs to move the smart terminal as required during the shooting of human face video; then determine whether the human face in the human face video is a living body according to the to-be-detected information. As compared with the living boy detection manner with pictures in the prior art, video usually contains more attack information. Furthermore, it is further possible to finally determine the living body or non-living body in conjunction with the movement information of the smart terminal during the shooting of the human face video, thereby improving the accuracy of the detection results. Furthermore, the solutions of the present disclosure are adapted for all of various commonly-used attack manners, and exhibit wide applicability.

### BRIEF DESCRIPTION OF DRAWINGS

FIG. 1 is a flow chart of an embodiment of a to-be-detected information generating method according to the present disclosure.

FIG. 2 is a flow chart of a first embodiment of a living body detecting method according to the present disclosure.

FIG. 3 is a flow chart of a second embodiment of a living body detecting method according to the present disclosure.

FIG. 4 is a structural schematic diagram of components of an embodiment of a to-be-detection information generating apparatus according to the present disclosure.

FIG. 5 is a structural schematic diagram of components of a living body detecting apparatus according to the present disclosure.

FIG. 6 illustrates a block diagram of an example computer system/server 12 adapted to implement an implementation mode of the present disclosure.

### DETAILED DESCRIPTION OF PREFERRED EMBODIMENTS

In view of the problems existing in the prior art, the present disclosure provides a to-be-detected information generating manner and a living body detecting manner. The living body detecting manner may depend on the to-be-detected information.

Technical solutions of the present disclosure will be described in more detail in conjunction with figures and embodiments to make technical solutions of the present disclosure clear and more apparent.

Obviously, the described embodiments are partial embodiments of the present disclosure, not all embodiments. Based on embodiments in the present disclosure, all other embodiments obtained by those having ordinary skill in the art without making inventive efforts all fall within the protection scope of the present disclosure.

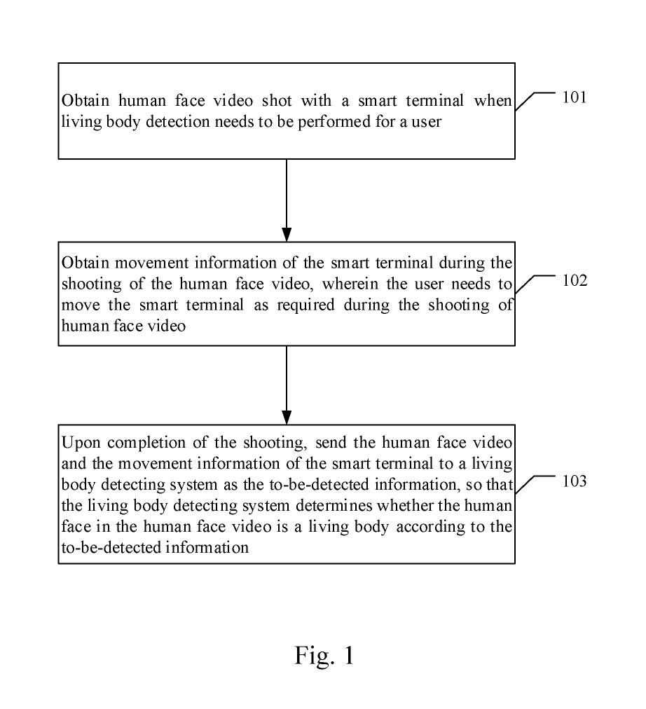

FIG. 1 is a flow chart of an embodiment of a to-be-detected information generating method according to the present disclosure. As shown in FIG. 1, the embodiment comprises the following specific implementation mode.

In 101, when living body detection needs to be performed for the user, human face video shot with a smart terminal is obtained.

102 relates to obtaining movement information of the smart terminal during the shooting of the human face video, wherein the user needs to move the smart terminal as required during the shooting of human face video.

103 relates to, upon completion of the shooting, sending the human face video and the movement information of the smart terminal to a living body detecting system as the to-be-detected information, so that the living body detecting system determines whether the human face in the human face video is a living body according to the to-be-detected information.

At present, the user uses the smart terminal more and more widely, so the present disclosure proposes that the living body detection may be performed for the user in conjunction with the user's smart terminal.

In other words, when the living body detection is performed, it is feasible to first require the user to shoot a section of video which may be human face video, and furthermore, during the shooting of the human face video, it is feasible to require the user to cooperate in moving the smart terminal, for example, moving the smart terminal farther or closer, and meanwhile obtain the movement information of the smart terminal during the shooting of the human face video.

Since a mobile phone is a smart terminal which is currently used most widely and almost every person has a mobile phone and usually carries the mobile phone with himself, it is feasible to use the mobile phone to shoot the human face video, and meanwhile obtain the movement information of the mobile phone during the shooting of the human face video.

In practical application, a subject for performing 101-103 shown in FIG. 1 may be an application (App) installed on the mobile phone.

Correspondingly, a user who needs to perform living body detection in the manner stated in the present disclosure may pre-install the abovementioned App on his mobile phone. When living body detection needs to be performed for the user, the user man open the App, send a corresponding instruction and thereby begin to shoot the human face video. Furthermore, during shooting, the App may send an instruction to the user to require the user to take the mobile phone farther or closer, thereby obtaining the operation information of the mobile phone. Upon completion of the shooting, the App may automatically send the shot human face video and obtained mobile phone operation information to a background living body detecting system as the to-be-detected information, so that the living body detecting system determines whether the human face in the human face video is a living body according to the to-be-detected information.

The operation information of the mobile phone may be obtained by virtue of a movement information collecting device in the mobile phone, for example, a gyro, an acceleration sensor and an Inertial Measurement Unit (IMU).

In addition, to prevent the sent instruction from being memorized by an attacking user, for example, to take the smart terminal farther, then closer and then farther, thereby counterfeiting the human face video, it is possible to randomly require the user to take the smart terminal farther or closer during the shooting of the human face video.

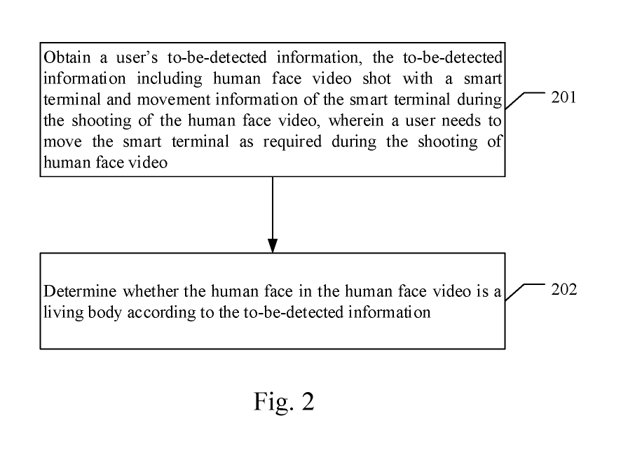

FIG. 2 is a flow chart of a first embodiment of a living body detecting method according to the present disclosure. As shown in FIG. 2, the embodiment comprises the following specific implementation mode.

201 relates to obtaining the user's to-be-detected information, the to-be-detected information including human face video shot with a smart terminal and movement information of the smart terminal during the shooting of the human face video, wherein the user needs to move the smart terminal as required during the shooting of human face video.

202 relates to determining whether the human face in the human face video is a living body according to the to-be-detected information.

The subject for performing 201-202 shown in FIG. 2 may be a background living body detecting system.

After obtaining the to-be-detected information, the living body detecting system may determine whether the human face in the human face video is a living body according to the human face video in the to-be-detected information and the movement information of the mobile phone, namely, obtain a living body detection result.

Preferably, it is feasible to judge whether a human face change direction in the human face video is consistent with the movement direction of the mobile phone, and if no, judge that the human face in the human face video is a non-living body.

For example, when the mobile phone is moved closer, the captured human face becomes larger; when the mobile phone is taken farther, the captured human face becomes smaller.

As stated above, attack manners often used by an attack user currently may include photos and video displayed on a mobile phone or Pad, and various photos printed on different materials.

The solution of the present disclosure will be further described below respectively in conjunction with the above attack manners.

1) Attack Using Pictures Printed on Paper Sheets

When the living body detection needs to be performed, the attack user, namely, illegal user, may open an App installed on the mobile phone, shoot human face video with respect to the legal user's pictures printed on the paper sheets and obtained in a certain manner, and move the mobile phone farther or closer as required during the shooting of human face video. Upon completion of the shooting, App sends the captured human face video and the movement information of the mobile phone during the shooting to the background living body detecting system for living body detection.

In this case, the human face change direction in the human face video is also consistent with the movement direction of the mobile phone, but texture information in pictures obtained by photographing a real person is very much different from texture information in pictures obtained by photographing pictures printed on paper sheets, particularly when the mobile is taken closer. When the mobile phone is taken farther, information about edges of the paper sheet can be easily exposed. Therefore, these characteristics may be used to distinguish the living body or non-living body.

2) Attack Using Pictures Displayed on the Mobile Phone

When the living body detection needs to be performed, the attack user may display, on the screen of the mobile phone, the legal user's pictures obtained in a certain manner, open an App installed on another mobile phone, shoot human face video with respect to the displayed pictures, and move the mobile phone farther or closer as required during the shooting of human face video. Upon completion of the shooting, App sends the captured human face video and the movement information of the mobile phone during the shooting to the background living body detecting system for living body detection.

In this case, the human face change direction in the human face video is also consistent with the movement direction of the mobile phone, but there will be some obvious attack features such as screen flash in the pictures obtained by photographing pictures displayed on the mobile phone screen. Furthermore, when the mobile phone is taken farther, information about edges of the mobile phone screen can be easily exposed. Therefore, these characteristics may be used to distinguish the living body or non-living body.

3) Attack Using Video Displayed on the Mobile Phone

The illegal user may use the mobile phone to pre-shoot a section of human face video. The shooting may also be performed in a manner of moving the mobile phone farther and closer.

When the living body detection needs to be performed, it is possible to use the mobile phone screen to play the shot human face video, open an App installed on another mobile phone, shoot the content that is being played, and keep the mobile phone immobile or move the mobile phone farther or closer as required during the shooting. Upon completion of the shooting, App sends the captured human face video and the movement information of the mobile phone during the shooting to the background living body detecting system for living body detection.

If the mobile phone is kept immobile during the shooting, the movement information of the mobile phone is empty. If the mobile phone is moved farther or closer as required during the shooting, since the requirement is sent randomly, the movement of the mobile phone is certainly different from the farther or closer movement while the legal user shoots the human face video, so that the human face change direction in the human face video is inconsistent with the movement direction of the mobile phone. Therefore, these characteristics may be used to distinguish the living body or non-living body.

In practical application, to improve the accuracy of the detection results, it is feasible to pre-train to obtain a classification model, and in a deep learning manner, enable the classification model to learn the above characteristics in the above various attack manners, thereby distinguishing the living body or non-living body.

To this end, it is necessary to respectively pre-obtain positive samples and negative samples as training data. The positive samples refer to training data that a final detection result is a living body. The negative samples refer to training data that a final detection result is a non-living body.

For example, it is possible to generate negative samples in the attack manners stated in 1), 2) and 3), and use a real person (living person) to generate positive samples in a normal operation manner.

The classification model may be obtained by training after a sufficient number of positive samples and negative samples are obtained. How to train is of the prior art.

Subsequently, when the living body detection needs to be performed, it is possible to input the human face video and the movement information of the mobile phone in the obtained to-be-detected information into the classification model, thereby obtaining an output detection result about whether the human face in the human face video is a living body.

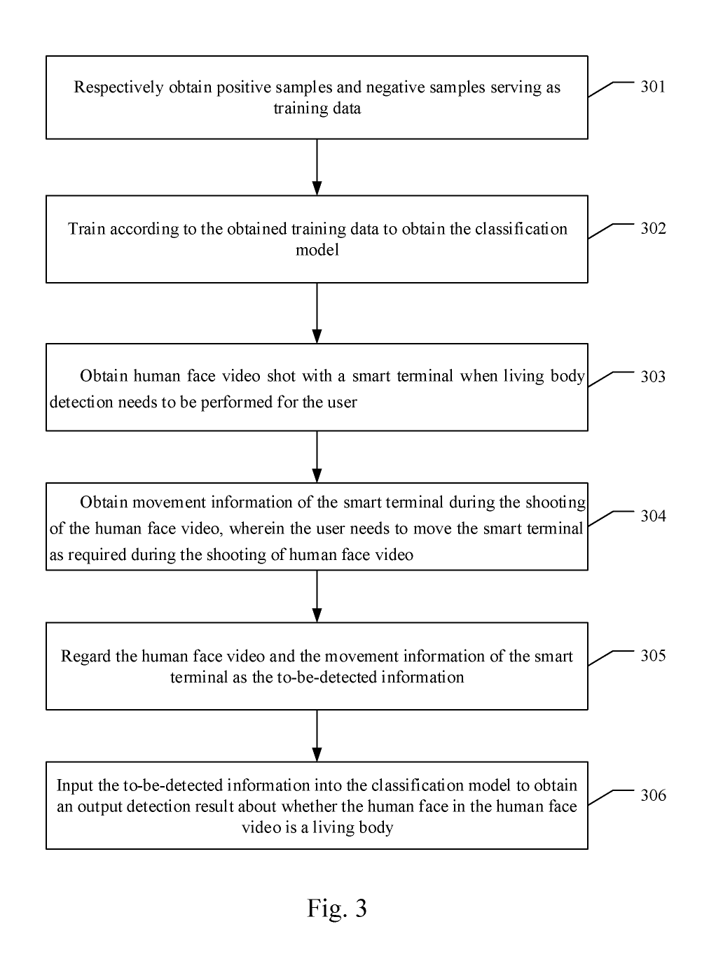

Based on the above introduction, FIG. 3 is a flow chart of a second embodiment of a living body detecting method according to the present disclosure. As shown in FIG. 3, the embodiment comprises the following specific implementation mode.

In 301, positive samples and negative samples serving as training data are obtained respectively.

For example, it is possible to generate negative samples in the attack manners stated in 1), 2) and 3), and use a real person (living person) to generate positive samples in a normal operation manner.

In 302, train according to the obtained training data to obtain the classification model.

The classification model may be a neural network model.

303 relates to obtaining human face video shot with a smart terminal when living body detection needs to be performed for the user.

In 304 is obtained movement information of the smart terminal during the shooting of the human face video, wherein the user needs to move the smart terminal as required during the shooting of human face video.

Moving the smart terminal may include moving the smart terminal farther or closer.

In 305, the human face video and the movement information of the smart terminal are regarded as the to-be-detected information.

In 306, the to-be-detected information is input into the classification model to obtain an output detection result about whether the human face in the human face video is a living body.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

To sum up, according to the solutions of the above method embodiments, it is feasible to obtain the user's to-be-detected information, the to-be-detected information including human face video shot with the smart terminal and movement information of the smart terminal during the shooting of the human face video, wherein the user needs to move the smart terminal as required during the shooting of human face video; then determine whether the human face in the human face video is a living body according to the to-be-detected information. As compared with the living boy detection manner with pictures in the prior art, video usually contains more attack information. Furthermore, it is further possible to finally determine the living body or non-living body in conjunction with the movement information of the smart terminal during the shooting of the human face video, thereby improving the accuracy of the detection results. Furthermore, the solutions of the present disclosure are adapted for all of various commonly-used attack manners, and exhibit wide applicability.

The above introduces the method embodiments. The solution of the present disclosure will be further described through an apparatus embodiment.

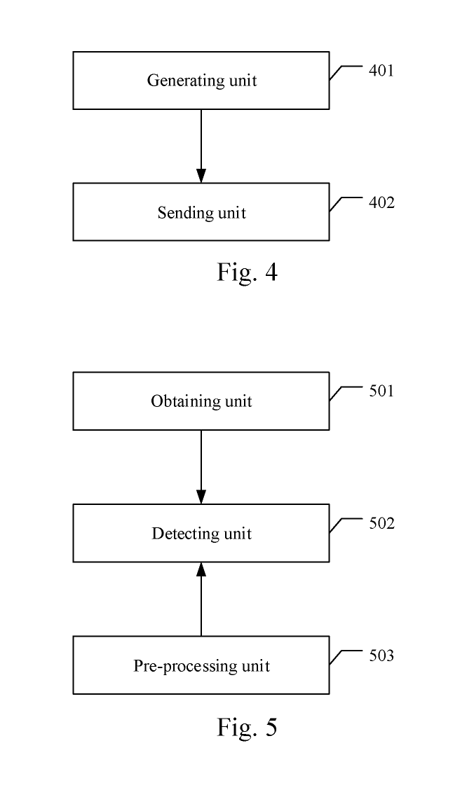

FIG. 4 is a structural schematic diagram of components of an embodiment of a to-be-detected information generating apparatus according to the present disclosure. As shown in FIG. 4, the apparatus comprises a generating unit 401 and a sending unit 402.

The generating unit 401 is configured to obtain human face video shot with a smart terminal when living body detection needs to be performed for the user; obtain movement information of the smart terminal during the shooting of the human face video, wherein the user needs to move the smart terminal as required during the shooting of human face video.

The sending unit 402 is configured to, upon completion of the shooting, send the human face video and the movement information of the smart terminal to a living body detecting system as the to-be-detected information, so that the living body detecting system determines whether the human face in the human face video is a living body according to the to-be-detected information.

At present, the user uses the smart terminal more and more widely, so the present disclosure proposes that the living body detection may be performed for the user in conjunction with the user's smart terminal.

In other words, when the living body detection is performed, it is feasible to first require the user to shoot a section of video which may be human face video, and furthermore, during the shooting of the human face video, it is feasible to require the user to cooperate in moving the smart terminal, for example, moving the smart terminal farther or closer, and meanwhile obtain the movement information of the smart terminal during the shooting of the human face video.

Since a mobile phone is a smart terminal which is currently used most widely and almost every person has a mobile phone and usually carries the mobile phone with himself, it is feasible to use the mobile phone to shoot the human face video, and meanwhile obtain the movement information of the mobile phone during the shooting of the human face video.

Correspondingly, the apparatus shown in FIG. 4 may be located in the mobile phone and serve as a component of the mobile phone, or may appear in the form of an App.

In addition, to prevent the sent instruction from being memorized by an attacking user, for example, take the smart terminal farther, then closer and then farther, thereby counterfeiting the human face video, it is possible to randomly require the user to take the smart terminal farther or closer during the shooting of the human face video.

FIG. 5 is a structural schematic diagram of components of a living body detecting apparatus according to the present disclosure. As shown in FIG. 5, the apparatus comprises an obtaining unit 501 and a detecting unit 502.

The obtaining unit 501 is configured to obtain the user's to-be-detected information, the to-be-detected information including human face video shot with a smart terminal and movement information of the smart terminal during the shooting of the human face video, wherein the user needs to move the smart terminal as required during the shooting of human face video.

The detecting unit 502 is configured to determine whether the human face in the human face video is a living body according to the to-be-detected information.

The obtaining unit 501 may obtain the to-be-detected information from the apparatus shown in FIG. 4 and send the obtained to-be-detected information to the detecting unit 502.

The detecting unit 502 may determine whether the human face in the human face video is a living body according to the human face video in the to-be-detected information and the movement information of the mobile phone, namely, obtain a living body detection result.

Preferably, the detecting unit 502 may judge whether a human face change direction in the human face video is consistent with the movement direction of the smart terminal, and if no, judge that the human face in the human face video is a non-living body.

Attack manners often used by an attack user currently may include attack using photos and video displayed on a mobile phone or Pad, and attack using various photos printed on different materials.

Referring to the depictions of various attack manners in the abovementioned 1), 2) and 3), in practical application, to improve the accuracy of the detection results, it is feasible to pre-train to obtain a classification model, and in a deep learning manner, enable the classification model to learn different characteristics in various attack manners, thereby distinguishing the living body or non-living body.

Correspondingly, the apparatus shown in FIG. 5 may further comprise: a pre-processing unit 503.

The pre-processing unit 503 is configured to respectively obtain positive samples and negative sample as training data, and train according to the obtained training data to obtain the classification model.

Wherein the positive samples refer to training data that a final detection result is a living body. The negative samples refer to training data that a final detection result is a non-living body.

For example, it is possible to generate negative samples in the attack manners stated in 1), 2) and 3), and use a real person to generate positive samples in a normal operation manner.

The classification model may be obtained by training after a sufficient number of positive samples and negative samples are obtained. How to train is of the prior art.

Subsequently, when the living body detection is performed, the detecting unit 502 may input the human face video and the movement information of the mobile phone in the obtained to-be-detected information into the classification model, thereby obtaining an output detection result about whether the human face in the human face video is a living body.

Reference may be made to corresponding depictions in the aforesaid method embodiments for a specific workflow of the apparatus embodiments shown in FIG. 4 and FIG. 5. The workflow is not detailed any more.

To sum up, according to the solutions of the above apparatus embodiments, it is feasible to obtain the user's to-be-detected information, the to-be-detected information including human face video shot with the smart terminal and movement information of the smart terminal during the shooting of the human face video, wherein the user needs to move the smart terminal as required during the shooting of human face video; then determine whether the human face in the human face video is a living body according to the to-be-detected information. As compared with the living boy detection manner with pictures in the prior art, video usually contains more attack information. Furthermore, it is further possible to finally determine the living body or non-living body in conjunction with the movement information of the smart terminal during the shooting of the human face video, thereby improving the accuracy of the detection results. Furthermore, the solutions of the present disclosure are adapted for all of various commonly-used attack manners, and exhibit wide applicability.

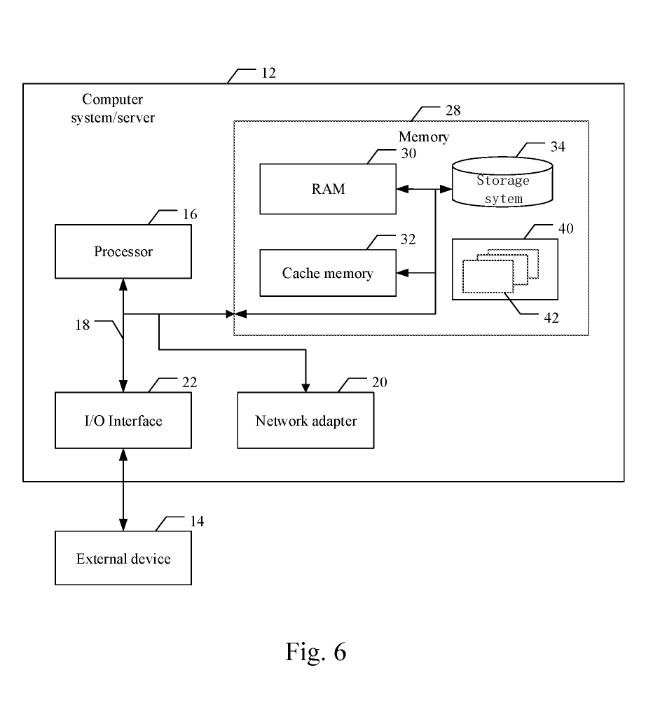

FIG. 6 illustrates a block diagram of an example computer system/server 12 adapted to implement an implementation mode of the present disclosure. The computer system/server 12 shown in FIG. 6 is only an example and should not bring about any limitation to the function and scope of use of the embodiments of the present disclosure.

As shown in FIG. 6, the computer system/server 12 is shown in the form of a general-purpose computing device. The components of computer system/server 12 may include, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown in FIG. 6 and typically called a “hard drive”). Although not shown in FIG. 6, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. The memory 28 may include at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might include an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted in FIG. 6, network adapter 20 communicates with the other communication modules of computer system/server 12 via bus 18. It should be understood that although not shown, other hardware and/or software modules could be used in conjunction with computer system/server 12. Examples, include, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the method in the embodiment shown in FIG. 1, 2 or 3, namely, obtain human face video shot with a smart terminal when living body detection needs to be performed for the user; obtain movement information of the smart terminal during the shooting of the human face video, wherein the user needs to move the smart terminal as required during the shooting of human face video; upon completion of the shooting, send the human face video and the movement information of the smart terminal to a living body detecting system as the to-be-detected information, so that the living body detecting system determines whether the human face in the human face video is a living body according to the to-be-detected information.

Reference may be made to related depictions in the above embodiments for specific implementations, which will not be detailed any more.

The present disclosure meanwhile provides a computer-readable storage medium on which a computer program is stored, the program, when executed by a processor, implementing the method stated in the embodiment shown in FIG. 1, 2 or 3.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A to-be-detected information generating method, wherein the method comprises:
obtaining human face video shot with a smart terminal when living body detection needs to be performed for a user;
obtaining movement information of the smart terminal during the shooting of the human face video, wherein the user needs to move the smart terminal as required during the shooting of human face video;
upon completion of the shooting, sending the human face video and the movement information of the smart terminal to a living body detecting system as the to-be-detected information, so that the living body detecting system determines whether the human face in the human face video is a living body according to the to-be-detected information.

2. The method according to claim 1, wherein the moving the smart terminal comprises:
moving the smart terminal farther or closer according to a random requirement.

3. A living body detecting method, wherein the method comprises:
obtaining a user's to-be-detected information, the to-be-detected information including human face video shot with a smart terminal and movement information of the smart terminal during the shooting of the human face video, wherein a user needs to move the smart terminal as required during the shooting of human face video;
determining whether the human face in the human face video is a living body according to the to-be-detected information.

4. The method according to claim 3, wherein the moving the smart terminal comprises:
moving the smart terminal farther or closer according to a random requirement.

5. The method according to claim 3, wherein the determining whether the human face in the human face video is a living body according to the to-be-detected information comprises:
inputting the to-be-detected information into a classification model obtained by pre-training, to obtain an output detection result about whether the human face in the human face video is a living body.

6. The method according to claim 5, wherein before obtaining the user's to-be-detected information, the method further comprises:
respectively obtaining positive samples and negative sample as training data;
training according to the obtained training data to obtain the classification model.

7. A computer device, comprising a memory, a processor and a computer program which is stored on the memory and runnable on the processor, wherein the processor, upon executing the program, implements a to-be-detected information generating method, wherein the method comprises:
obtaining human face video shot with a smart terminal when living body detection needs to be performed for a user;
obtaining movement information of the smart terminal during the shooting of the human face video, wherein the user needs to move the smart terminal as required during the shooting of human face video;
upon completion of the shooting, sending the human face video and the movement information of the smart terminal to a living body detecting system as the to-be-detected information, so that the living body detecting system determines whether the human face in the human face video is a living body according to the to-be-detected information.

8. The computer device according to claim 7, wherein the moving the smart terminal comprises:
moving the smart terminal farther or closer according to a random requirement.

9. A computer-readable storage medium on which a computer program is stored, wherein the program, when executed by a processor, implements a to-be-detected information generating method, wherein the method comprises:
obtaining human face video shot with a smart terminal when living body detection needs to be performed for a user;
obtaining movement information of the smart terminal during the shooting of the human face video, wherein the user needs to move the smart terminal as required during the shooting of human face video;
upon completion of the shooting, sending the human face video and the movement information of the smart terminal to a living body detecting system as the to-be-detected information, so that the living body detecting system determines whether the human face in the human face video is a living body according to the to-be-detected information.

10. The computer-readable storage medium according to claim 9, wherein the moving the smart terminal comprises:
moving the smart terminal farther or closer according to a random requirement.

11. A computer device, comprising a memory, a processor and a computer program which is stored on the memory and runnable on the processor, wherein the processor, upon executing the program, implements a living body detecting method, wherein the method comprises:
obtaining a user's to-be-detected information, the to-be-detected information including human face video shot with a smart terminal and movement information of the smart terminal during the shooting of the human face video, wherein a user needs to move the smart terminal as required during the shooting of human face video;
determining whether the human face in the human face video is a living body according to the to-be-detected information.

12. The computer device according to claim 11, wherein the moving the smart terminal comprises:
moving the smart terminal farther or closer according to a random requirement.

13. The computer device according to claim 11, wherein the determining whether the human face in the human face video is a living body according to the to-be-detected information comprises:
inputting the to-be-detected information into a classification model obtained by pre-training, to obtain an output detection result about whether the human face in the human face video is a living body.

14. The computer device according to claim 13, wherein before obtaining the user's to-be-detected information, the method further comprises:
respectively obtaining positive samples and negative sample as training data;
training according to the obtained training data to obtain the classification model.

15. A computer-readable storage medium on which a computer program is stored, wherein the program, when executed by a processor, implements a living body detecting method, wherein the method comprises:
obtaining a user's to-be-detected information, the to-be-detected information including human face video shot with a smart terminal and movement information of the smart terminal during the shooting of the human face video, wherein a user needs to move the smart terminal as required during the shooting of human face video;
determining whether the human face in the human face video is a living body according to the to-be-detected information.

16. The computer-readable storage medium according to claim 15, wherein the moving the smart terminal comprises:
moving the smart terminal farther or closer according to a random requirement.

17. The computer-readable storage medium according to claim 15, wherein the determining whether the human face in the human face video is a living body according to the to-be-detected information comprises:
inputting the to-be-detected information into a classification model obtained by pre-training, to obtain an output detection result about whether the human face in the human face video is a living body.

18. The computer-readable storage medium according to claim 17, wherein before obtaining the user's to-be-detected information, the method further comprises:
respectively obtaining positive samples and negative sample as training data;
training according to the obtained training data to obtain the classification model.
